(19) United States
(12) Patent Application Publication
(10) Pub. No.: US 2019/0389107 A1
(43) Pub. Date: Dec. 26, 2019

(54) VEHICLE OUTER SURFACE COMPONENT AND METHOD FOR PRODUCING A VEHICLE OUTER SURFACE COMPONENT

(71) Applicant: Webasto SE, Stockdorf (DE)

(72) Inventors: Frank KIESEWETTER, Stockdorf (DE); Magnus SVIBERG, Stockdorf (DE); Matthias BAUMANN, Stockdorf (DE)

(21) Appl. No.: 16/441,175

(22) Filed: Jun. 14, 2019

(30) Foreign Application Priority Data
Jun. 25, 2018 (DE) 102018115242.6

(51) Int. Cl. B29C 45/16; B32B 3/12; B32B 27/40; B32B 5/02; B29C 70/48; B60R 13/02; B60J 7/00

(52) U.S. Cl. CPC B29C 45/1679; B32B 3/12; B32B 27/40; B32B 5/022; B29C 70/48; B29K 2075/00; B60J 7/0007; B32B 2250/04; B32B 2255/10; B32B 2255/26; B32B 2605/08; B60R 13/0212

(57) ABSTRACT

The invention relates to a vehicle outer surface component with a layer structure with an SMC layer forming an outer shell layer and a reinforcement structure connected to the SMC layer and having a core layer, wherein it is provided according to the invention that an IMC-TOPcoat-layer is mounted on the outside on the SMC layer, which together with the SMC layer forms the outer shell layer.

The invention relates to a vehicle outer surface component with a layer structure with an SMC layer forming an outer shell layer and with a reinforcement structure connected to the SMC layer and having a core layer, and a method of producing a vehicle outer surface component.

Such a vehicle outer surface component is, for example, a cover of a roof opening system such as a sliding roof or spoiler roof, a surface component of a roof module or a trim component of a vehicle.

From EP 1 524 175 A2 a vehicle outer surface component is known having an outer shell made of a plastic with high surface quality, e. g. from an SMC material, and a reinforcement structure abutting an inner surface of the outer shell. The reinforcement structure comprises two spaced-apart plastic layers, between which a honey comb structure or a foam-like material is provided. The outer shell made of a plastic with high surface quality allows painting analogously to a sheet metal component. However, a downstream painting causes high costs that can make the production of such a vehicle outer surface component uneconomical.

The invention is based on the object to create a vehicle outer surface component mentioned at the outset that can be produced at low cost and high component quality, as well as to provide a method for producing such a vehicle outer surface component.

In the case of the vehicle outer surface component mentioned at the outset this object is achieved according to the invention in that an IMC-TOPcoat layer is attached on the outside of the SMC layer, which forms the outer shell layer together with the SMC layer.

The object is furthermore achieved by a method having the features of claim 7 as well as by a method having the features of claim 9.

Advantageous embodiments of the invention are indicated in the dependent claims.

The outside IMC-TOPcoat layer, which is in particular made of a polyurethane or a 2K polyurethane paint or the like, replaces an IMC-primer used otherwise which forms a primer for a subsequent paint, as well as a paint. The SMC layer obtains a Class A surface quality.

The SMC layer is preferably formed with a layer thickness of about 1.0 mm to 2.5 mm. The thickness of the SMC layer is chosen to cover the underlying structure to a high quality, so that no bumps or the like occur or are recognizable at the surface of the SMC layer covered by the IMC-TOPcoat layer.

A high-gloss surface is obtained either by a corresponding high-gloss surface in the tool or by subsequent polishing of the component. In this case, a greater layer thickness of the IMC-TOPcoat layer of about 120 μm (0.120 mm) to 140 μm (0.140 mm) is appropriate.

High-gloss, matt or structured component surfaces are obtained in accordance with the tool surface. Preferably, contrasting colors can be made. On the other hand, the color of the color paint of the vehicle can be used.

The vehicle outer surface component according to the invention has numerous advantages:

elimination of a complex and expensive paint;

elimination of a logistics effort, if otherwise an external paint shop is used;

excellent lightweight construction factor: grammages as a function of the total component stiffnesses of below 4 kg/m² are possible, for example (depending on the application);

with a tool different colors of the outer shell layer or the component can be produced;

with a lower tool and different upper tools different structures of the surfaces can be generated.

The SMC layer decouples from the reinforcement structure, in particular of a core layer formed by a honey comb (e. g. PHC). No further decoupling layers are necessary. Even partially reinforced or thinned areas are not visible on the surface. In combination with the IMC-TOPcoat layer class A components can be produced, which can be removed from the tool in high quality.

The SMC layer with the IMC-TOPcoat layer attached thereto is formed such that it has high scratch resistance, high UV resistance and high color fastness. In the production process, these material properties and in particular adhesion or adhesive power of the IMC-TOPcoat layer can be influences, for example, by controlling the injection time in the tool.

Appropriately, the reinforcement structure includes an inner plastic cover layer containing predominantly polyurethane or is made of polyurethane and is attached to the core layer on its inside opposite the outer shell layer. The attachment of the plastic cover layer to the core layer is done by means of the polyurethane as an adhesive, which provides for an intimate bond with the core layer and may penetrate it in case of a suitable material for this purpose. On the inside of the component, a fabric can be laminated directly.

In a preferred embodiment, the outer shell layer is attached by means of an outer plastic coating layer containing predominantly polyurethane or is made of polyurethane, to the outside of the core layer facing the outer shell layer. The outer plastic cover layer may have a reinforcement, e. g. by fiber reinforcement or a fiber mat, whereby the strength is increased. For the attachment of the outer shell, it is possible to use both an outer plastic covering layer reinforced in such a way and an outer plastic covering layer provided without this reinforcement.

It is particularly preferred that the inner plastic cover layer and/or the outer plastic cover layer has a fiber reinforcement, e. g. with glass fibers, or a fiber mat. The optional use of a fiber or fiber mat reinforcement allows a specific design of the different layers with respect to an optimized high strength, in particular bending strength or strength against hail, for example. The plastic or the polyurethane essentially forms the adhesive, while the fiber reinforcement provides the requisite strength.

A particularly preferred embodiment provides that the core layer of the reinforcement structure is made of a honey comb or a foam. In this case the honey comb can be preferably made of paper (PHC), aluminum or a plastic such as, e. g., phenolic resin. Honey combs are also understood to mean, e. g., wave-like components or spacers which extend perpendicular to the at least one plastic cover layer.

By a method according to the invention according to claim 7 a high-quality vehicle outer surface component can be produced, in particular, as described above. The method for producing a vehicle outer surface component, which is formed in particular according to the preceding explanation, includes the steps of:

a) producing an SMC layer including an IMC-TOPcoat layer as a semi-finished product forming an outer shell layer, in a standard production method for SMC components,

b) inserting the outer shell layer in a tool half of a composite tool,

c) injecting a reinforcement structure bearing the outer shell layer having a core layer covered by at least one plastic cover layer, with still non-crosslinked adhesive or polyurethane in the SMC layer of the outer shell layer with molding the vehicle outer surface component, and

d) demolding the vehicle outer surface component produced with high-quality finished outer shell.

Appropriately, following the demolding of the vehicle outer surface component (step d), at least one further method step such as trimming or cutting the edges of the vehicle outer surface component can be performed.

Furthermore, a high-quality vehicle outer surface component can likewise be produced by a method according to the invention according to claim 9. Here, the following steps are carried out:

a) producing an SMC layer as a semi-finished product in a standard production method for SMC components,

b) inserting the SMC layer in a first tool half of a molding tool and pressing the SMC layer by means of a second tool half,

c) applying an IMC-TOPcoat layer on the SMC layer facing the first tool half to form an outer shell layer,

d) replacing the second tool half with a tool half having an enlarged mold cavity,

e) inserting a reinforcement structure bearing the outer shell layer, the reinforcement structure having a core layer covered by at least one plastic cover layer, in the enlarged mold cavity,

f) injecting the reinforcement structure having still non-crosslinked adhesive or polyurethane in the SMC layer of the outer shell layer with molding the vehicle outer surface component, and

g) demolding the vehicle outer surface component produced with high-quality finished outer shell.

The IMC-TOPcoat layer is in particular made of a polyurethane or a 2K polyurethane paint or the like.

As with the former method, a further method step can be carried out after demolding. Painting is not intended and not required.

Below, the invention will be explained in more detail with reference to an exemplary embodiment of a vehicle outer surface component with reference to the drawing.

FIG. 1 shows in a sectional view a vehicle outer surface component according to the invention;

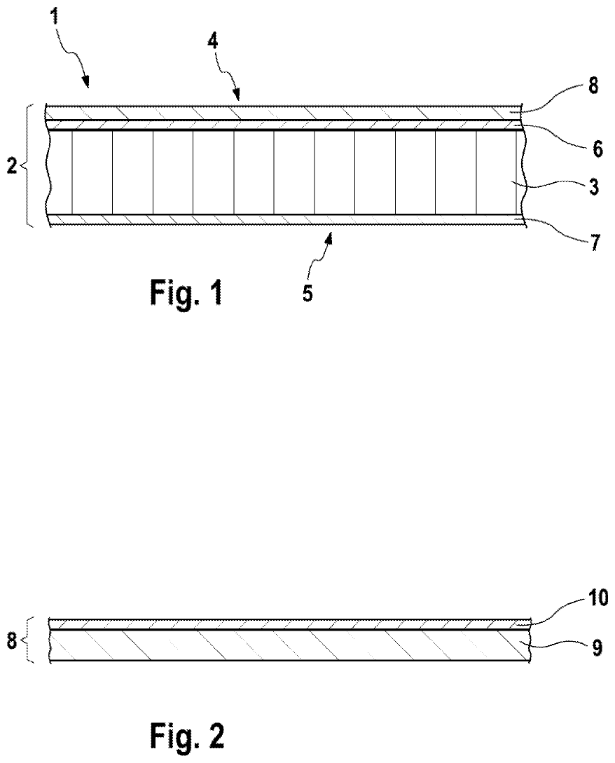

FIG. 2 shows in a sectional view an outer shell layer of the vehicle outer surface component of FIG. 1;

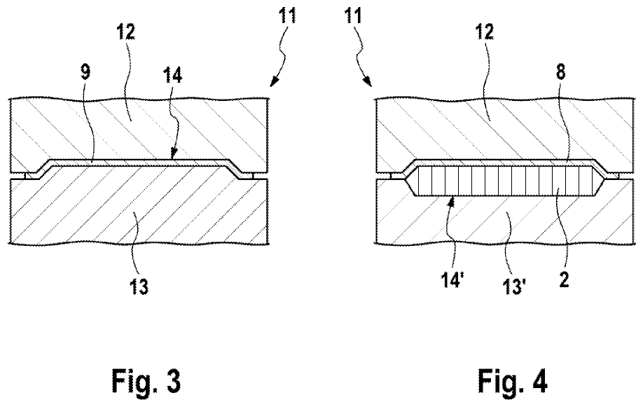

FIG. 3 shows in a sectional view a molding tool with two closed tool halves and an SMC semi-finished product of the vehicle outer surface component disposed therein during a first production step; and

FIG. 4 shows in a sectional view the molding tool with a second replaced tool half and a vehicle outer surface component disposed therein during a second production step.

A vehicle outer surface component 1, which is, e. g., a cover of a roof module or an openable roof, such as a sliding roof, has a reinforcement structure 2 with a core layer 3 that is made of a honey comb, for example a paper honey comb (PHC), or is made of a foam. Preferably, the core layer 3 is provided on both sides, i. e. facing the outside 4 of the component and also facing the inside 5 of the component of the vehicle outer surface component 1, with a plastic cover layer 6 and 7, respectively. The outer plastic cover layer 6 as well as the inner plastic cover layer 7 contain a thin adhesive layer or are formed by such layer that consists in particular of polyurethane, and contain in particular a reinforcing fiber layer or fiber mat, made, e. g., of a fiber material having basalt fibers, carbon fibers, natural fibers or glass fibers.

An outer shell layer 8 of the vehicle outer surface component 1 is connected to reinforcement structure 2 or core layer 3 by means of the plastic or polyurethane of the outer plastic cover layer 6. Outer shell layer 8 is formed of an inner layer and an outer layer. The inner layer is a thin SMC layer 9 having a thickness of preferably about 1.0 mm to 2.5 mm. The outer layer is an IMC-TOPcoat layer 10 (IMC In Mold Coat) of a thickness of preferably about 60 to 140 μm (0.060 to 0.140 mm).

The IMC-TOPcoat layer 10 is a high-quality layer, so that a subsequent painting is not provided and is not necessary. Rather, high-gloss, matt or structured component surfaces can be generated according to the tool surface in the molding tool, wherein the IMC-TOPcoat layer 10 itself can have a coloring e. g. in car color or also can have contrast colors.

The SMC layer 9 coated with IMC-TOPcoat layer 10 is then injected with the PHC support or the reinforcement structure. This gives a lightweight Class A component without additional painting.

A high-gloss surface is obtained either by a corresponding high-gloss surface in the tool or by subsequent polishing of the component. Appropriately, then a larger layer thickness of about 120 μm (0.120 mm) to 140 μm (0.140 mm) is provided.

The outer plastic cover layer 6 may also be omitted as a fibrous layer, if SMC layer 9 takes over the structural properties of the outer plastic cover layer 6. The bonding of SMC layer 9 directly to core layer 3 is then carried out only by plastic such as, e. g., polyurethane.

A method of producing such a vehicle outer surface component 1 provides for producing first an SMC layer 9 including an outer high quality IMC-TOPcoat layer 10 as a semi-finished product in a standard production method for SMC components.

Subsequently, the semi-finished product (SMC layer 9 with IMC-TOPcoat layer 10) is inserted in a tool half of a composite tool. If necessary, the semi-finished product is drawn to the tool half with vacuum.

In a further downstream method step, the reinforcement structure 2 is injected into the semi-finished product with still non-crosslinked adhesive (z. B. polyurethane). In this method step the shaping of the reinforcement structure 2 at the surface facing SMC layer 9 is carried out.

Optionally, following the demolding of the composite component or vehicle outer surface component 1 further method steps take place, such as trimming or cutting the edges of vehicle outer surface component 1. In any case, the need for a subsequent painting is eliminated.

A further alternative method (see FIGS. 3 and 4) provides the combination of an SMC process with a composite process. A molding tool 11 has a first or upper tool half 12 and a second or lower tool half 13. SMC layer 9 is pressed first in a mold cavity 14 between the two tool halves 12 and 13, and then flooded with an IMC-TOPcoat layer 10 by means of the first or upper tool half 12 (Class A tool half) on the subsequent outside of the component. In contrast to the first-mentioned method, the semi-finished product or the outer shell layer 8 (SMC layer 9 with IMC-TOPcoat layer 10) is not removed from molding tool 11, rather the counterpunch of molding tool 11, i. e., the lower tool half 13, is replaced by a second tool half 13′ for producing the final composite geometry. This can be done by exchanging the counterpunch or by a shuttling or displacing tool half 13 or 13′, wherein SMC layer 9 remains at the upper tool half 12. The replaced lower tool half 13′ has an enlarged mold cavity 14′ in which reinforcement structure 2 is disposed. This is followed by the composite process, in which the reinforcement structure 2 is pressed against SMC layer 9 of outer shell layer 8 and connected thereto.

Alternatively, the lower tool half 13 may also be the Class A tool half, and both the lower tool half 13 and the upper tool half 12 may be shuttled. Optionally, SMC layer 9 may also remain on the lower tool half 13′ and the process for attaching the reinforcement structure 2 may be done in a second pressing tool.

Great advantage of this method is the elimination of additional handling steps for moving the semi-finished product, avoiding damage to the later surface, and avoiding of contamination of the composite tool with impurities.

The individual features of the invention disclosed in the description and by the exemplary embodiment as well as in the figures may be combined in any technically appropriate arrangements and configurations with the subject matter of the invention in its general form.

### LIST OF REFERENCE NUMERALS

1 vehicle outer surface component
2 reinforcement structure
3 core layer
4 outside of the component
5 inside of the component
6 outer plastic cover layer
7 inner plastic cover layer
8 outer shell layer
9 SMC layer
10 IMC-TOPcoat layer
11 molding tool
12 first tool half
13 second tool half
13′ replaced second tool half
14 mold cavity
14′ enlarged mold cavity

1. A vehicle outer surface component with a layer structure with an SMC layer forming an outer shell layer and a reinforcement structure connected to the SMC layer and having a core layer,
wherein an IMC-TOPcoat-layer is mounted on the outside on the SMC layer, which together with the SMC layer forms the outer shell layer.

2. The vehicle outer surface component according to claim 1,
wherein the IMC-TOPcoat layer has a thickness of 60 to 140 μm (0.060 to 0.140 mm).

3. The vehicle outer surface component according to claim 1,
wherein the core layer of the reinforcement structure is made of a honeycomb or a foam, especially wherein the honeycomb is made of paper, aluminum or a plastic such as phenolic resin.

4. The vehicle outer surface component according to claim 1,
wherein the reinforcement structure has an inner plastic cover layer, which is made of polyurethane and is mounted to the core layer on its inside opposite the outer shell layer.

5. The vehicle outer surface component according to claim 1,
wherein the outer shell layer is mounted by means of an outer plastic cover layer, which is made of polyurethane, to the outside of the core layer facing the outer shell layer.

6. The vehicle outer surface component according to claim 4, characterized in that the inner plastic cover layer and/or the outer plastic cover layer has a fiber reinforcement or a fiber mat.

7. A method of making a vehicle outer surface component, in particular according to claim 1, comprising the steps of:
a) producing an SMC layer including an IMC-TOPcoat layer as a semi-finished product forming an outer shell layer, in a standard production method for SMC components,
b) inserting the outer shell layer in a tool half of a composite tool,
c) injecting a reinforcement structure bearing the outer shell layer having a core layer covered by at least one plastic cover layer, with still non-crosslinked adhesive or polyurethane in the SMC layer of the outer shell layer with molding the vehicle outer surface component, and
d) demolding the vehicle outer surface component produced with high-quality finished outer shell.

8. The method according to claim 7,
wherein, following the demolding of the vehicle outer surface component (step d), performing at least one further method step such as trimming or cutting the edges of the vehicle outer surface component.

9. A method of producing a vehicle outer surface member in particular according to claim 1, comprising the steps of:
a) producing an SMC layer as a semi-finished product in a standard production method for SMC components,
b) inserting the SMC layer in a first tool half of a molding tool and pressing the SMC layer by means of a second tool half,
c) applying an IMC-TOPcoat layer on the SMC layer facing the first tool half to form an outer shell layer,
d) replacing the second tool half with a tool half having an enlarged mold cavity,
e) inserting a reinforcement structure bearing the outer shell layer, the reinforcement structure having a core layer covered by at least one plastic cover layer, in the enlarged mold cavity,
f) injecting the reinforcement structure having still non-crosslinked adhesive or polyurethane in the SMC layer of the outer shell layer with molding the vehicle outer surface component, and
g) demolding the vehicle outer surface component produced with high-quality finished outer shell.

10. The vehicle outer surface component according to claim 1,
wherein the IMC-TOPcoat layer is a layer which is made of a polyurethane or a 2K polyurethane paint or the like in Class A surface quality and which replaces a primer and/or a subsequent paint.
